(19) United States
(12) Patent Application Publication
(10) Pub. No.: US 2008/0296203 A1
(43) Pub. Date: Dec. 4, 2008

(54) Hydrocarbon Conversion Process Using Nanosized Particles

(76) Inventors: Dennis Stamires, Dana Point, CA (US); Paul O'Connor, Hoevelaken (NL); Elbert Jan De Graaf, Utrecht (NL)

Correspondence Address: Albemarle Netherlands B.V.;Patent and Trademark Department, 451 Florida Street, Baton Rouge, LA, 70801, US

(21) Appl. No.: 11/661,247

(22) PCT Filed: Aug. 25, 2005
(86) PCT No.: PCT/EP05/54180

§ 371 Date: Apr. 1, 2008

Related U.S. Application Data
(60) Provisional application No. 60/604,699, filed on Aug. 27, 2004.

(51) Int. Cl. B01J 29/70

(52) U.S. Cl. 208/46

(57) ABSTRACT

Hydrocarbon conversion process comprising the steps of (a) suspending catalyst particles comprising a layered material in a first, polar hydrocarbon, employing conditions such as will cause delamination of the layered material to form a suspension comprising particles with a size of less than 1 micron, (b) optionally adding the suspension to a second hydrocarbon, (c) converting the first and/or the optional second hydrocarbon in the presence of said delaminated layered material, and (d) separating the delaminated material from the first and the optional second hydrocarbon. This process provides an economically desired way of converting hydrocarbons using small catalyst particles.

Heterogeneous catalysts used for hydrocarbon conversion reactions generally have a size of at least about 40 microns (microspheres) up to several millimeters (in case of extrudates or pellets). The processes conducted using these catalyst particles are generally governed by mass transfer limitations and/or accessibility limitations. In consequence, it is not unusual that only a fraction of the catalytic sites present on the catalyst particles are effectively utilized.

One approach to solving these problems is to use very small catalyst particles, preferably of less than 1 micron, suspended in a hydrocarbon, as described in J.A.C.S. 125 (2003) pp. 5479-5485, and U.S. Pat. No. 3,975,259.

U.S. Pat. No. 3,975,259 discloses a hydrodesulfurisation process which involves the steps of suspending a hydroconversion catalyst having a nominal particle size of less than 10 microns, e.g. 0.1-9 microns, in a liquid hydrocarbon feedstock and feeding the resulting suspension together with a hydrogen-rich gas through a contact zone at an elevated temperature and pressure. The catalyst comprises Ni, Co, Mo, and/or W supported on alumina, silica, magnesia, and/or zeolite. The small particles are obtained by, e.g., grinding, before their addition to the liquid hydrocarbon feedstock to be converted.

A. Takagaki et al. (J.A.C.S. 125 (2003) 5479-5485) disclose the use of nanosheets originating from layered metal oxides HTiNbO₅ and HSr₂Nb₃O₁₀ as catalysts for the esterification of acetic acid, cracking of cumene, and dehydrogenation of 2-propanol.

These nanosheets are prepared by adding tetra(n-butylammonium)hydroxide (TBAOH) to an aqueous suspension of HTiNbO₅ and HSr₂Nb₃O₁₀, respectively, and shaking the resulting suspension for 3-7 days. Insertion of the voluminous TBA⁺ cations between the layers causes expansion of the layers, resulting in delamination of the individual metal oxide sheets.

The suspension is then centrifuged and the nanosheets are precipitated from the supernatant. Before use as a catalyst in the above reaction, the precipitated nanosheets are evacuated in inert atmosphere to remove water.

This way of preparing small catalyst particles is rather cumbersome.

It is therefore an object of the present invention to provide a process for the conversion of hydrocarbons using catalyst particles with a size of less than 1 micron resulting from delaminating a layered material, which catalyst particles are obtained in an economically more desired manner.

The present invention relates to a hydrocarbon conversion process comprising the steps of:
a) suspending catalyst particles comprising a layered material in a first, polar hydrocarbon, employing conditions such as will cause delamination of the layered material to form a suspension comprising particles with a size of less than 1 micron,
b) optionally adding the suspension to a second hydrocarbon,
c) converting the first and/or the optional second hydrocarbon in the presence of said delaminated layered material, and
d) separating the delaminated material from the first and the optional second hydrocarbon.

With this process, layered materials are delaminated by suspending them in a hydrocarbon (the first hydrocarbon) and then used to convert this first hydrocarbon and/or a subsequently added hydrocarbon (the second hydrocarbon).

Layered materials are crystalline materials built up from layers (sheets) which are assembled in a way generally referred to as the stacking order. Between the layers, charge balancing anions or cations are accommodated.

In the present specification delamination is defined as distorting the stacking order of the layered material by (partly) de-layering the structure. So, the individual layers are essentially kept intact, but their usual ordering is distorted. As a result, the crystallinity of the material (as determined by X-ray diffraction) decreases.

The term delamination also includes the extreme case which leads to a random dispersion of individual layers in a medium, thereby leaving no stacking order at all. This extreme case is referred to in this specification as exfoliation.

Hence, delaminated layered materials are materials with a distorted stacking order as a result of delamination.

### Step a)

The first step of the process involves suspending solid particles comprising a layered material in a first hydrocarbon, thereby delaminating the layered material to form a suspension comprising particles with a size of less than 1 micron.

The term “layered material” includes anionic clays, layered hydroxy salts, cationic clays, and cationic layered materials.

Anionic clays (also referred to in the prior art as hydrotalcite-like material and layered double hydroxide) have a crystal structure consisting of positively charged layers built up of specific combinations of divalent and trivalent metal hydroxides between which there are anions and water molecules. Hydrotalcite is an example of a naturally occurring anionic clay in which the trivalent metal is aluminium, the divalent metal is magnesium, and the predominant anion is carbonate; meixnerite is an anionic clay in which the trivalent metal is aluminium, the divalent metal is magnesium, and the predominant anion is hydroxyl.

Layered hydroxy salts (LHS) are distinguished from anionic clays in that they are built up of divalent metals only, whereas layered double hydroxides are built up of both a divalent and a trivalent metal. An example of a LHS is a hydroxy salt of a divalent metal according to the following idealised formula: [(Me²⁺,M²⁺)₂(OH)₃]⁺(Xⁿ⁻)_{1/n}], wherein Me²⁺ and M²⁺ may be the same or different divalent metal ions and X is an anion other than OH—. Another example of LHS has the general formula [(Me²⁺,M²⁺)₅(OH)₈]²⁺ (Xⁿ⁻)_{2/n}], wherein Me²⁺ and M²⁺ may be the same or different divalent metal ions and X is an anion other than OH—.

If the LHS contains two different metals, the ratio of the relative amounts of the two metals may be close to 1. Alternatively, this ratio may be much higher, meaning that one of the metals predominates over the other. It is important to appreciate that these formulae are ideal and that in practice the overall structure will be maintained although chemical analysis may indicate compositions not satisfying the ideal formula.

The LHS-structures described above may be considered an alternating sequence of modified brucite-like layers in which the divalent metal(s) is/are coordinated octrahedrally with hydroxide ions. In one family, structural hydroxyl groups are partially replaced by other anions (e.g. nitrate) that may be exchanged. In another family, vacancies in the octahedral layers are accompanied by tetrahedrically coordinated cations.

For further structural details as well as work on layered hydroxy salts the following publications are referenced: J. Solid State Chem. 148 (1999) 26-40, Solid State Ionics 53-56 (1992) 527-533, Inorg. Chem. 32 (1993) 1209-1215, J. Mater. Chem. 1 (1991) 531-537, Reactivity of Solids, 1, (1986) 319-327, and Reactivity of Solids, 3, (1987) 67-74

Cationic clays differ from anionic clays in that they have a crystal structure consisting of negatively charged layers built up of specific combinations of tetravalent, trivalent, and optionally divalent metal hydroxides between which there are cations and water molecules. Examples of cationic clays include smectites (including montmorillonite, beidellite, nontronite, hectorite, saponite, Laponite™, and sauconite), bentonite, illites, micas, glauconite, vermiculites, attapulgite, and sepiolite.

Cationic Layered Materials (CLMs) are crystalline NH₄-Me(II)-TM-O phases with a characteristic X-ray diffraction pattern. In this structure, Me(II) represents a divalent metal and TM stands for a transition metal. The structure of a CLM consists of negatively charged layers of divalent metal octrahedra and transition metal tetrahedra with charge-compensating cations sandwiched between these layers. For more information concerning CLMs reference may be had to M. P. Astier et al. (Ann. Chim. Fr. Vol. 12, 1987, pp. 337-343) and D. Levin, S. Soled, and J. Ying (Chem. Mater. Vol. 8, 1996, 836-843; ACS Symp. Ser. Vol. 622, 1996, 237-249; Stud. Surf. Sci. CataL. Vol. 118, 1998, 359-367).

Depending on the reaction to be catalysed during the process of the invention, the solid particles comprising a layered material can consist of 100% layered material. However, these particles can also contain other materials, such as zeolites (e.g. faujasite or pentasil-type zeolites), alumina, silica, magnesia, mesoporous materials (MCM-type materials), transition metal oxides or hydroxides, metal compounds, etc. These materials may be suitable for catalytic purposes in step c). The other material preferably is present in the particles in an amount of less than 50 wt %, more preferably less than 25 wt %.

The first hydrocarbon is of polar nature, meaning that the hydrocarbon contains one or more heteroatoms, such as nitrogen, sulfur and/or oxygen attached to aromatic and/or naphthenic rings. Examples of such hydrocarbons are aromatic light cycle oil, heavy oils like rapeseed oil, atmospheric or vacuum residues, FCC gasoline or cycle oils, and coker gas oils.

The catalyst particles comprising layered material that are added to the first hydrocarbon generally have a diameter of less than 200 microns, preferably 1-3 microns.

While mixing the catalyst particles comprising the layered material with the first hydrocarbon, the layered material will delaminate, thereby forming a suspension containing nanosized particles. The size of these nanosized particles, expressed as their median diameter, is less than 1 micron, preferably less than 800 nm, more preferably less than 600 nm, and most preferably less than 500 nm. The nanosized particles are generally larger than 50 nm, preferably larger than 200 nm, in order to be able to separate the particles from the hydrocarbon by, e.g., nanofiltration, distillation, or centrifugation.

The median diameter of the particles is determined by measuring the diameter of a representative number of particles as viewed by electron microscopy. The median diameter is the middle of the distribution: 50% of the number of particles are above the median diameter and 50% are below the median diameter.

Step a) may be conducted at temperatures in the range of 20-400° C., preferably 50 to 300° C., and more preferably 70 to 200° C., at atmospheric or higher—preferably autogeneous—pressure. The specific conditions depend on, e.g., the first hydrocarbon, the type of layered material, and the kinetics of delamination in this system, but in general the temperature is preferably below the normal, i.e. atmospheric, boiling point of the first hydrocarbon.

The suspension formed in step a) preferably has a solids content of less than 25 wt %, more preferably 5-15 wt %.

The kinetics of delamination depend on the compatibility and interaction between the layered material and the first hydrocarbon. In order to enhance delamination, high shear can be applied to the suspension or ultrasound waves can be introduced into the suspension.

### Step b)

A second hydrocarbon can be added to the suspension.

If it is not the first hydrocarbon which is to be converted in step c), then this second hydrocarbon will be the one to be so converted. However, it is also possible to convert both the first and the second hydrocarbon in step c).

This way, if the hydrocarbon to be converted is not very suitable for delaminating the layered material, it is possible to first delaminate the layered material in a more suitable hydrocarbon (the first hydrocarbon), after which it is then mixed with the hydrocarbon to be converted (the second hydrocarbon).

So, the second hydrocarbon can be any hydrocarbon feed that needs to be converted in step c).

Examples of second hydrocarbons are oxygenates, hydrocarbons containing alcohol and/or acid groups, hydrocarbons containing nitrogen and/or sulfur heteroatoms, amino acids, unsaturated hydrocarbons (olefins), hydrocarbons for ionic polymerisation, heavy oils, heavy crude oils, tar sands, biomass materials, and mixtures thereof.

The heavy oils, heavy crude oils, and tar sands may contain various contaminants, such as heavy metals (e.g. Fe, V, Ni), S, N, and/or O-containing species, and/or naphthenic acids.

The biomass materials may contain O-containing species.

### Step c)

Step c) involves the hydrocarbon conversion reaction. Examples of such hydrocarbon conversion reactions are polymerisation (e.g. polymerisation of rapeseed oil), hydrodesulfurisation, hydrodenitrogenation, hydrogenation, dehydrogenation, and liquid-phase cracking.

It will be evident that the choice of layered material and optional other materials to be present in the catalyst particles will depend on the envisaged hydrocarbon conversion reaction. For instance, if hydrodesulfurisation (HDS) or hydrodenitrogenation (HDN) is envisaged, the catalyst particles preferably contain Ni, Co, Mo, and/or other metals usually present in or on HDS or HDN catalysts. Said metals can be incorporated into or onto the layered material by ion exchange or impregnation.

The conditions applied during step c) will be the same as those known in the art for performing these conversion reactions, except of course for the hydroconversion catalyst applied.

The suspended particles can be separated from the obtained products by, e.g., centrifugation, nano-filtration or distillation.

### EXAMPLES

### Example 1

Hydrotalcite particles with a size of about 70 micrometers (25 mg) were added to 100 ml of rapeseed oil under stirring. The mixture was heated to 105° C. After stirring for 72 hours, a clear liquid was obtained. Hence, the hydrotalcite particles were no longer visually observable, indicating that the hydrotalcite must have been delaminated, thereby forming particles which a size of significantly less than 1 micon.

The clear liquid was very viscous. GC analysis showed that more than 50 wt % of the rapeseed oil was converted into a polymer.

This experiment shows that layered materials can be delaminated in polar hydrocarbons and at the same time convert these hydrocarbons.

### Example 2

Example 1 was repeated, except that the temperature of the rapeseed oil-hydrotacite suspension was 80° C. Again, a clear liquid was obtained. Again, part of the rapeseed oil was converted into a polymer.

1. A hydrocarbon conversion process comprising the steps of:
a) suspending catalyst particles comprising a layered material in a first, polar hydrocarbon, employing conditions such as will cause delamination of the layered material to form a suspension comprising particles with a size of less than 1 micron,
b) optionally adding the suspension to a second hydrocarbon,
c) converting the first and/or the optional second hydrocarbon in the presence of said delaminated layered material, and
d) separating the delaminated material from the first and the optional second hydrocarbon.

2. The process according to claim 1 wherein the first hydrocarbon is an aromatic light cycle oil.

3. The process according to claim 1 wherein step a) is conducted under high shear.

4. The process according to claim 1 wherein step a) is accompanied by ultrasonic treatment.

5. The process according to claim 1 wherein during step a) a supercritical fluid is added to the suspension, thereby forming a supercritical suspension, after which the pressure of the supercritical suspension is released.

6. The process according to claim 1 wherein the layered material is selected from the group consisting of anionic clays, cationic clays, cationic layered materials, and layered hydroxy salts.
